(19) United States
(12) Patent Application Publication
(10) Pub. No.: US 2015/0356545 A1
(43) Pub. Date: Dec. 10, 2015

(54) Machine Implemented Method of Processing a Transaction Document

(71) Applicants: Ralph Edward Marcuccilli, Fort Wayne, IN (US); Brian Mortin Runschlag, Ft Wayne, IN (US); Robert Graham Graham, Fort Wayne, IN (US)

(72) Inventors: Ralph Edward Marcuccilli, Fort Wayne, IN (US); Brian Mortin Runschlag, Ft Wayne, IN (US); Robert Graham Graham, Fort Wayne, IN (US)

(21) Appl. No.: 14/216,260

(22) Filed: Jun. 9, 2014

(51) Int. Cl. G06Q 20/32; G06K 9/62; G06K 9/46; G06Q 20/14

(52) U.S. Cl. CPC G06Q 20/322; G06Q 20/14; G06K 9/6202; G06K 9/4604

(57) ABSTRACT

A computer implemented method for mobile image capture and processing of financial transaction where one or more programmed processors perform the steps.

### REFERENCE TO RELATED APPLICATIONS

This application claims priority from U.S. provisional patent application Ser. No. 61/791,353 filed on Mar. 15, 2013, which is are hereby incorporated by reference into the present application for letters patent.

### BACKGROUND

1. Field

In general, embodiments of the invention relate to financial transactions and, more particularly, to a system for processing financial transactions using mobile communication device.

2. Description of the Prior Art

Over 90% of the 14,000 banks and credit unions in the U.S. offer internet bill payment service to their consumer customers. However, only 23% of total payments use the online bill pay service. With over half of all adults now using smartphones, the shift to mobile as the primary device has created a demand for simple, easy to use, intuitive mobile bill pay services. Although, traditional internet bill pay generates high margins for the large providers, they have failed to mike the transition to provide convenient mobile bill pay capabilities to their users. Mobile application developers are frustrated with the lack of accessible features and functionality that their mobile constituents are demanding.

The present invention is the first, and only, bill payment capture solution for mobile devices that maximizes the convenience and simplicity using smartphone equipped cameras. The present invention provides a system and method for users to take a picture of an invoice or bill which is uploaded, analyzed, archived and updated in the mobile bill payment payee file for future payment. In addition to camera input, the present invention aggregates multiple bill pay capture methods including e-invoice scan and archive and adding payees using only voice recognition.

Typically, person-to-person payments are conducted with cash, credit cards, online exchanges, or personal checks. Unfortunately, service providers, creditors, and sellers of physical products, often face a difficult dilemma. Credit card payments provide immediate funds, but the purchaser can dispute the payment for as much as six month under current U.S. law. Additionally, the seller must absorb or pass along the fee for accepting a credit card payment. Conversely, the depositor of a check is only at risk of a check being disputed for 24 hours after the bank has honored the payment.

Thus, in a further embodiment, the present invention comprises a system and method for payees to create an online account to through which purchasers of payee's goods or services may pay for such goods and services by taking a picture of a check or other transaction document and uploading the image to a payee's account for processing the transaction.

Unfortunately, prior art systems and methods for conducting online financial transactions, illustrative examples of which are presented in chronological order below, do not address the advantages inherent in the present invention.

U.S. Pat. No. 8,577,118 discloses an automated document processing and more particularly, to methods and systems for document image capture and processing using mobile devices. In accordance with various embodiments, methods and systems for document image capture on a mobile communication device are provided such that the image is optimized and enhanced for data extraction from the document as depicted. These methods and systems may comprise capturing an image of a document using a mobile communication device; transmitting the image to a server; and processing the image to create a hi-tonal image of the document for data extraction. Additionally, these methods and systems may comprise capturing a first image of a document using the mobile communication device; automatically detecting the document within the image; geometrically correcting the image; binarizing the image; correcting the orientation of the image; correcting the size of the image; and outputting the resulting image of the document.

U.S. Pat. No. 8,538,124 discloses systems and methods for real-time validation of check image quality and readability of MICR line data are provided. A check image received by a financial institution can be assessed during a customer on-line session, so that the customer is informed in real-time whether the image is acceptable. Received check images are used to produce images in another format, which are then analyzed for specified requirements.

U.S. Pat. No. 8,483,473 discloses systems and methods for applying for and creating balance transfers with a mobile device are provided. An image of a customer's financial statement can be taken using a mobile device, after which the image is analyzed to extract information relevant to creating a balance transfer. The extracted information is then communicated to a bank over a network connected with the mobile device, where the bank can process the information and create an offer to the customer for a balance transfer in real-time. An example financial statement is a credit card statement. These systems and methods may comprise capturing an image of a document using a mobile communication device; transmitting the image to a server; detecting relevant information within the image; transmitting the information to a bank; and transmitting a resulting balance transfer offer from the bank to the mobile device.

U.S. Pat. No. 8,478,020 discloses a system wherein a customer account number is received via an interface of a document processing device. A plurality of documents associated with the deposit transaction is received in an input receptacle of the document processing device. The plurality of documents is transported, one at a time, along a transport path from the input receptacle past an image scanner to one or more output receptacles. Each document is imaged with the image scanner to produce image data associated with the deposit transaction. The image data is reproducible as a visually readable image of at least a portion of each document. Deposit information is generated from the image data associated with the deposit transaction. The customer account number is associated with the generated deposit information. The deposit information is transmitted from the document processing device to a teller system.

U.S. Pat. No. 8,437,531 discloses a check and U.S. bank note processing device configured to process both checks and U.S. bank notes. According to one embodiment, the device comprises an input receptacle configured to receive checks and U.S. bank notes and an output receptacle. The device further comprises a transport mechanism configured to transport the checks and U.S. bank notes from the input receptacle past an image scanner. The image scanner is configured to obtain an image of each check and U.S. bank note transported past the image scanner. The device is configured to determine the denominations of transported U.S. bank notes. The device is configured to capture information from checks transported past the image scanner. The device further comprises a memory configured to store the information captured from checks transported past the image scanner.

U.S. Pat. No. 8,396,279 discloses a method and a system for transaction decision making. According to an exemplary embodiment, a method and system for processing payment items involve receiving a payment item at a sorter device; extracting electronic data from the payment item from an electronic readable line of the payment item; imaging the payment item to obtain image data of the payment item; comparing the electronic data and the image data to verify payment data associated with the payment item; and determining an optimal settlement path for the payment item, at the sorter device.

U.S. Pat. No. 7,957,577 discloses a method is provided of a financial institution presenting an image of a bank document hi a check truncation environment. The method comprises determining security permission level associated with a person to be presented with the image of the bank document, determining type of the bank document, locating a first sensitive area associated with the bank document, and presenting on a screen of a monitor the image of the bank document with the first sensitive area in the image being selectively blanked out based upon the security permission level associated with the person to be presented with the image of the bank document.

Thus, a need remains for a system and method to conduct financial transactions using electronic communication means while maintaining the speed, lower cost, and certainty of cash or check transactions.

### SUMMARY

The present invention comprises a system and method for capturing and processing images of transaction documents such as remittance coupons and checks uses a mobile device with a camera, such as a mobile phone or tablet. Image optimization and enhancement allows data to be extracted from a remittance coupon or check for processing.

In one exemplary embodiment, a system according to the present invention comprises: a means for acquiring an electronic image; a means for extracting data from said image; means for populating predetermined data fields with said extracted data; a first database of user specific prior payee information; means for comparing populated data fields to said user specific prior payee information; means for determining a result of said comparison, where said result is selected from the group consisting of a complete match of said data fields to a prior payee, a partial match of said data fields to a prior payee, and no match of said data fields to a prior payee; means for selectively electronically and manually completing incomplete data fields with payee information; means for comparing said completed data fields with a database of all payees; means for updating said databases with new data; means for identifying acceptable payment methods for each payee; means for selecting a payment method among said acceptable payment methods; and means for executing said payment.

In another embodiment, a method of the present invention comprises the steps of: receiving a captured image of a transaction document; identifying text and any machine readable data on the image; extracting data fields from the image; populating a transaction record with transaction data fields from the extracted data fields; comparing and matching the transaction data fields of the transaction record with like data fields of a stored transaction record to determine if the transaction record is a complete transaction record or an incomplete transaction record, wherein the complete transaction record has all of the transaction data fields of the transaction record match all of the like data fields of the stored transaction record and wherein the incomplete transaction record has at least one unmatched transaction data field of the transaction record fail to match one of the like data fields of the stored transaction record; determining if the unmatched transaction data field from the incomplete transaction record contains invalid data, and editing the invalid data of the unmatched data field to match the like data field of the stored transaction record; determining if the unmatched transaction data field from the incomplete transaction record contains new valid data, and inputting the new valid data into a like data field of a new stored record; determining if the unmatched transaction data field from the incomplete transaction record is empty, and inputting data into the empty data field to match the like data field of the stored transaction record; validating the transaction data fields of the complete transaction record; and scheduling an outcome of the financial transaction.

In another exemplary embodiment, a method of the present invention comprises: the steps of: acquiring an electronic image of a transaction document; extracting data from said transaction document; inputting user specific data; populating predetermined data fields from said transaction document data and said user specific data; maintaining a first database of user specific payee information; maintaining a second data base of all payees; comparing said populated data fields to said user specific payee information; if said transaction and user inputted data match the data fields of said first database, validate said data against said second database, then execute the financial transaction; if said transaction and user inputted data does not match the data fields of said first database manually enter unmatched information and validate said data against said second database, then execute the transaction.

### BRIEF DESCRIPTION OF TUE DRAWINGS

The present invention will be understood more fully from the detailed description given hereinafter and from the accompanying drawings of the preferred embodiment of the present invention, which, however, should not be taken to limit the invention, but are for explanation and understanding only. In the drawings:

FIG. 1 is an illustrative high level block diagram of a computer network;

FIG. 2 is an illustrative block diagram of some of the elements of an exemplary standard computer;

FIG. 3 is an illustrative block diagram of some of the elements of an exemplary standard mobile device;

FIG. 4 is a block diagram of an image acquisition processing system;

FIG. 5 is a flow diagram showing a first exemplary embodiment of a transaction document processing system according to the present invention; and

FIG. 6 is a flow diagram showing a second exemplary embodiment of a transaction document processing system according to the present invention.

### DETAILED DESCRIPTION OF THE EMBODIMENTS

The present invention will be discussed hereinafter in detail in terms of the preferred embodiment according to the present invention with reference to the accompanying drawings. In the following description, numerous specific details are set forth in order to provide a thorough understanding of the present invention. It will be obvious, however, to those skilled in the art that the present invention may be practiced without these specific details. In other instances, well-known structures are not shown in detail in order to avoid unnecessary obscuring of the present invention.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations.

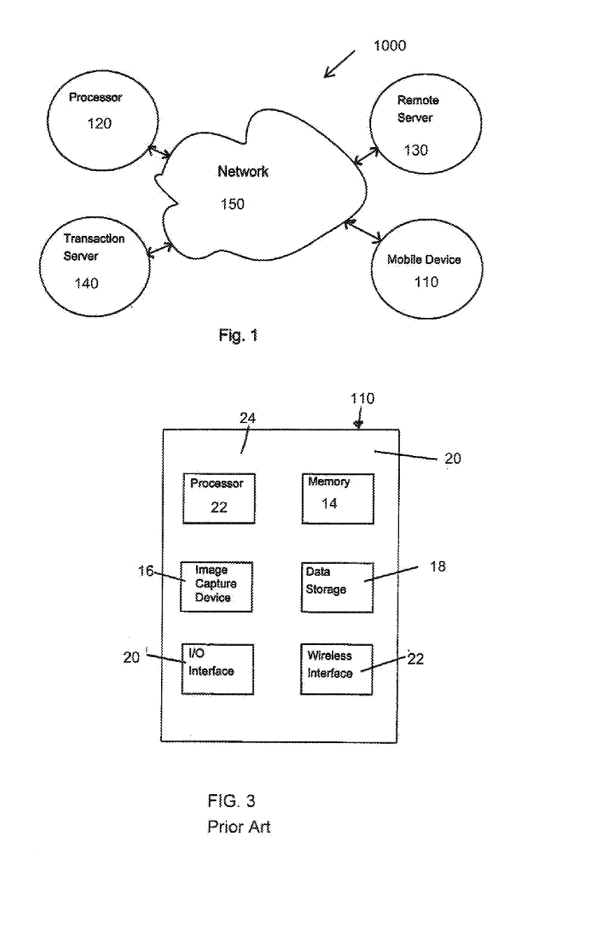

All of the embodiments described below are exemplary implementations of the present invention provided to enable persons skilled in the art to make or use the embodiments of the disclosure, they are not intended to limit the scope of the disclosure, which is defined by the claims. In the present description, the terms “upper”, “lower”, “left”, “rear”, “right”, “front”, “vertical”, “horizontal”, and derivatives thereof shall relate to the invention as oriented in FIG. 1.

Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Moreover, the terms “computer program medium” and “computer usable medium” are used to generally refer to physical storage media such as, RAM, ROM, a hard drive, or other memory storage device. These and other various forms of computer program media or computer usable media may store one or more sequences of one or more instructions to a processing device for execution. Such instructions embodied on the medium, are generally referred to as “computer program code” or a “computer program product” (which may be grouped in the form of computer programs or other groupings). When executed, such instructions may enable the computing module to perform features or functions of the present invention as discussed herein.

Turning first to FIG. 1, there is shown a functional block diagram of an exemplary computer system for use with the present invention. As shown in FIG. 1, system 1000 generally comprises: at least one mobile device 110, at least one computer processor 120, a remote server 130, and a transaction (or payment) server 140, and a communication network 150, such as the Internet.

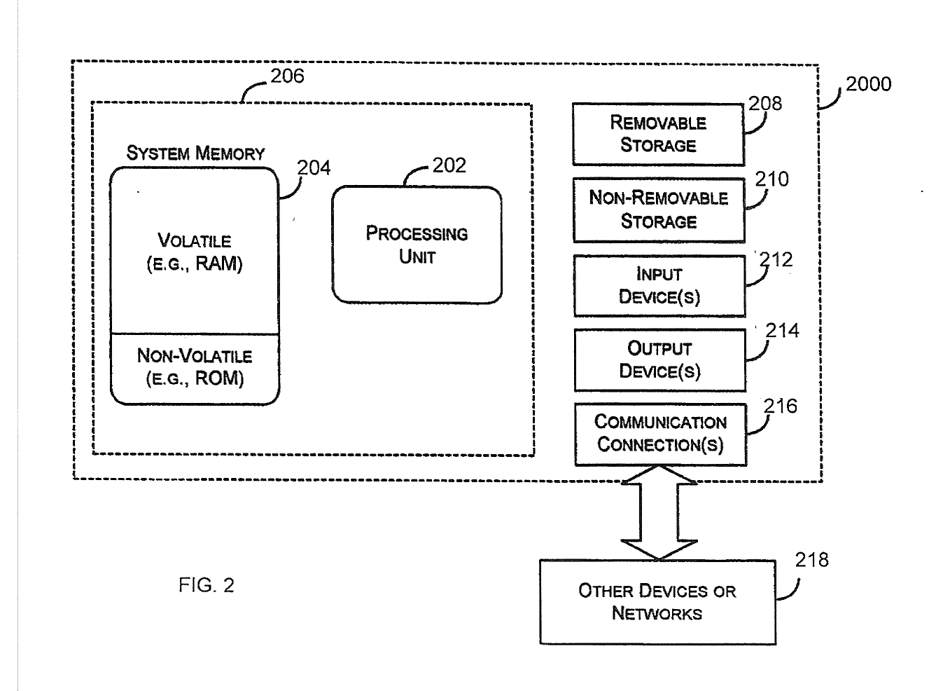

Referring next to FIG. 2, there is shown a functional block diagram generally illustrating a computing device 2000, one or more of which may be adapted for use in the illustrative system for implementing the invention. The computing device may be, for example, a personal computer, a handheld device such as a cell phone, tablet or a personal digital assistant, multi-processor systems, microprocessor-based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

In its most basic configuration, computing device 2000 typically includes at least one processing unit 202 and system memory 204. Depending on the exact configuration and type of computing device, system memory 204 may be volatile (such as RAM), non-volatile (such as ROM, flash memory, etc.) or some combination of the two. The basic configuration of the device 2000 is illustrated in FIG. 2 within dashed line 206.

Device 2000 may also have additional features and functionality. For example, device 2000 may also include additional storage (removable and/or non-removable) including, but not limited to, magnetic or optical disks or tape. Such additional storage is illustrated in FIG. 1 by removable storage 208 and non-removable storage 210. Computer storage media includes volatile and nonvolatile, removable and non-removable media implemented in any method or technology for storage of information such as computer readable instructions, data structures, program modules, or other data. System memory 204, removable storage 208, and non-removable storage 210 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by device 2000. Any such computer storage media may be part of device 2000.

Device 2000 includes one or more input devices 212 such as a keyboard, mouse, pen, puck, voice input device, touch input device, scanner, or the like. One or more output devices 214 may also be included, such as a video display, audio speakers, a printer, or the like. Input and output devices are well known in the art and need not be discussed at length here.

Device 2000 also contains communications connection 216 that allows the device 2000 to communicate with other devices 218, such as over a local or wide area network. Communications connection 216 is one example of communication media. Communication media includes any information delivery media that serves as a vehicle through which computer readable instructions, data structures, program modules, or other data may be delivered on a modulated data signal, such as a carrier wave or other transport mechanism. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, electromagnetic (e.g., radio frequency), infrared, and other wireless media. The term computer readable media as used herein includes both storage media and communication media.

Turning now to FIG. 3, there is shown an illustrative block diagram of an exemplary prior art mobile device, such as a smart phone, tablet computer, notebook computer, laptop computer, or the like for use with one or more aspects of the present invention. As shown in FIG. 3, mobile device 110 generally comprises a processor 12, a memory storage device 14, an image capture device 16, a data storage device 18, a plurality of input/output interfaces 20, and a wireless communication interface 22, where all of these components are in electronic communication with one another and contained within a physical housing 24.

Mobile device 110 includes a mobile processor 12. Mobile processor 12 can be a microprocessor or the like that is configurable to execute program instructions stored in mobile memory 14 and/or the mobile data storage 18. Mobile memory 14 is a computer-readable memory that stores data and/or computer program instructions for execution by processor 12. Mobile memory 14 can include volatile memory, such as RAM and/or persistent memory, such as flash memory. Mobile data storage 18 is a computer readable storage medium that can be used to store data and or computer program instructions. Mobile data storage 18 includes a hard drive, flash memory, a SD card, and other types of data storage.

Mobile device 110 also includes image capture device 16, such as a digital camera. Image capture device 16 can include various features, such as auto-focus, optical zoom or digital zoom. Image capture device 16 captures image data and stores the data in mobile memory 14 and/or mobile data storage 18 of mobile device 110.

Mobile device 110 uses a wireless interface 22 to send and/or receive data across a wireless network. The wireless network can be a wireless LAN, a mobile phone carrier's network, Bluetooth, or other types of wireless network.

I/O interface 20 allows mobile device 110 to exchange data with peripherals such as a personal computer system. A USB interface allows the connection of mobile device 110 to a USB port of a personal computer system to transfer data such as contact information to and from the mobile device and/or to transfer image data captured by image capture device 16 to the personal computer system.

As used herein, the term “module” may describe a given unit of functionality that can be performed. As used herein, a module may use any form of hardware, software, or a combination thereof. A module can include one or more processors, controllers, ASICs, PLAs, logical components, software routines or other mechanisms. Any module described herein may be used as discrete modules or the functions and features described can be shared in part or in total among one or more modules.

Referring collectively to FIGS. 1-3, transaction document processing system 1000 comprises transaction server 140 in communication via network 150 with one or more remote servers 130, processors 120, and mobile devices 110. Remote server 130 can be configured to process payments, deposits, and other types of financial transactions. Transaction server 140 and remote server 130 can be separate entities with separate server that communicate via network 150, or the same entity using separate servers or separate modules of the same server in communication with each other.

Mobile device 110 can capture an image of a remittance coupon, for example, to make an electronic payment. Processor 120 receives the captured image of the remittance coupon and an image of a check from the transaction server 140. Processor 120 can electronically deposit the check into a bank account associated with the entity for which the electronic remittance is being performed. Remote server 138 and the processor 120 can be part of the same server or same set of servers.

Processor 120 can operate by or on behalf of an entity associated with a transaction document, such as a check, a written statement, a remittance coupon, or the like. The user's account can then be linked with a bank, PayPal, electronic peer to peer payment, credit card, virtual currency (such as Bitcoin), or other account, such that when processor 120 receives the remittance information, it can charge the appropriate amount to the user's account.

Once an image is captured and corrected, data from the image is extracted and adjusted. The corrected image, data, and any required credential information, such as username, password, and phone or device identifier, can be transmitted to the transaction server 140 for further processing.

An image of a transaction document is captured, for example, using a camera or other image capture device 16 of the mobile device 110. For example, a user of the mobile device 110 can click a button, touch a screen, or otherwise activate the image capture device 16 (manually or automatically) to capture an image of a remittance coupon.

Mobile device 110 can receive and transmit additional information from the user, such as account information, proposed time to execute a transaction, mailing address, etc. Mobile device 110 prompts the user to enter data, such as a payment amount for the amount of the desired payment. The payment amount can differ from the account balance or minimum payment amount shown on the remittance coupon.

Mobile device 110 can perform some preprocessing of the captured image. Mobile device 110 can be programmed to convert the mobile image from a color image to a grayscale image or to bitonal image. Mobile device 110 can also be programmed to identify the corners of the remittance coupon and to perform geometric corrections and/or warping corrections to correct defects in the mobile image. Mobile device 110 can then transmit the mobile image of the remittance coupon and any additional data provided by user to transaction server 140.

Preferably, mobile device 110 captures an image of a transaction document associated with a particular transaction or account. Images taken with a mobile device's camera, can be 24 bit per pixel (24 bit/pixel) JPG images, although other types of images can be taken.

The captured image is typically a color image which is received and converted into a hi-tonal image of the document that is substantially equivalent in its resolution, size, and quality to document images produced by “standard” scanners, typically 1600×1200 pixels. “Standard” scanners can scan documents and produce high quality images, support resolutions from 200 to 300 dots per inch (DPI), produce gray-scale and bi-tonal images, and crop a smaller image from a larger full-page size image. Standard scanners for other types of documents may have similar capabilities with even higher resolutions and higher color-depth.

Mobile device 110 can be programmed to detect the transaction document within the captured image. Mobile processor 12 within mobile device 110 generates a document subimage that includes at least a portion of the captured image that corresponds to the transaction document before sending the document subimage to either remote server 130 or the transaction server 140. Once the transaction document is found in the image, one or more processors 120 are programmed to receive and detect the captured image of the transaction document sent from Mobile device 110. Because the transaction documents are usually rectangular, this detection finds at least one of the corners of the transaction document.

Processor 120 generates a document subimage that includes at least a portion of the captured image. The document subimage is corrected by processor 120, such as geometrically, to generate a corrected image. Processor 120 further processes the corrected image to generate a processed image. One or more mobile image quality assurance tests on the processed image are executed to assess the quality of the processed image. Remote server 130 of the transaction server 140 processes the sent image using image enhancement software as needed, either within the server or to other modules. The image is flattened, straightened and “cleaned” of extraneous information. Shadows, stray marks, and the like are reduced or removed. If the sent image cannot be enhanced or read after enhancement, a message is sent to the user to resend the captured image, to recapture the document or to manually input information from the document. Alternatively, the image can be read by a transaction service manually and entered into the system.

Again, mobile device 110 transmits the captured image to remote server 130 such as a web server or a transaction servicer's server by communicating with remote server 130 through network 150. This communication can use a wireless communication medium, such as Wi-Fi, Bluetooth, mobile telephone network, and the like, or through a secured wired communication system, such as through a computer in communication with network 150. Remote server 130 can send optional processing parameters to mobile device 110 for the selection of additional processing by remote server 130. Remote server 130 can also detect and decode the indicia, such as a barcode, associated with the captured transaction document to extract the encoded information.

At remote server 130, the captured image may be enhanced using a program, such as the one disclosed by Mitek Systems, San Diego, Calif. in U.S. Pat. No. 8,577,118, the disclosure of which is incorporated herein by reference. Image enhancement allows data to be found and extracted from less than ideal images of the transaction document for processing. Alternatively, the captured image is sent to transaction server 140 via network 150 for enhancement. Image quality assurance testing and processing can be used on remote server 130 or transaction server 140.

Network 150 can have one or more wireless and/or wired network connections. In some cases, the images can be transmitted over a mobile communication device network, such as a code division multiple access (“CDMA”) telephone network, or other mobile telephone network. Network 150 can also have one or more connections across the internet.

Transaction server 140 can have an image correction module, a test execution module and a transaction processing module. The image correction module corrects the captured image of the transaction document to generate a geometrically corrected image and process the geometrically corrected image at the server to generate a processed image. The test execution module executes one or more mobile image quality assurance tests on the processed image to assess the quality of the processed image and to provide the processed image to the transaction processing module if the processed image passes the mobile image quality assurance tests. The transaction processing module executes one or more transaction processing steps on the processed image.

The transaction server 140 can communicate with one or more processors 12 to prepare the captured image before processing by a remote processor 14 and ensures that the images are of a sufficient quality for the remote processor 120 to process. If the image quality is insufficient, the system will either reject the image and request a new picture, or process the image manually to extract data for transaction server 140.

Transaction server 140 can send the processed images to the processor 120 via network 150. Transaction server 140 can send additional processing parameters and data to processor 12 and remote processor 120 with the processed mobile image. The processing parameters and data can include information collected from the user with mobile device 110. Transaction server 140 can use hardware or a combination of software and hardware.

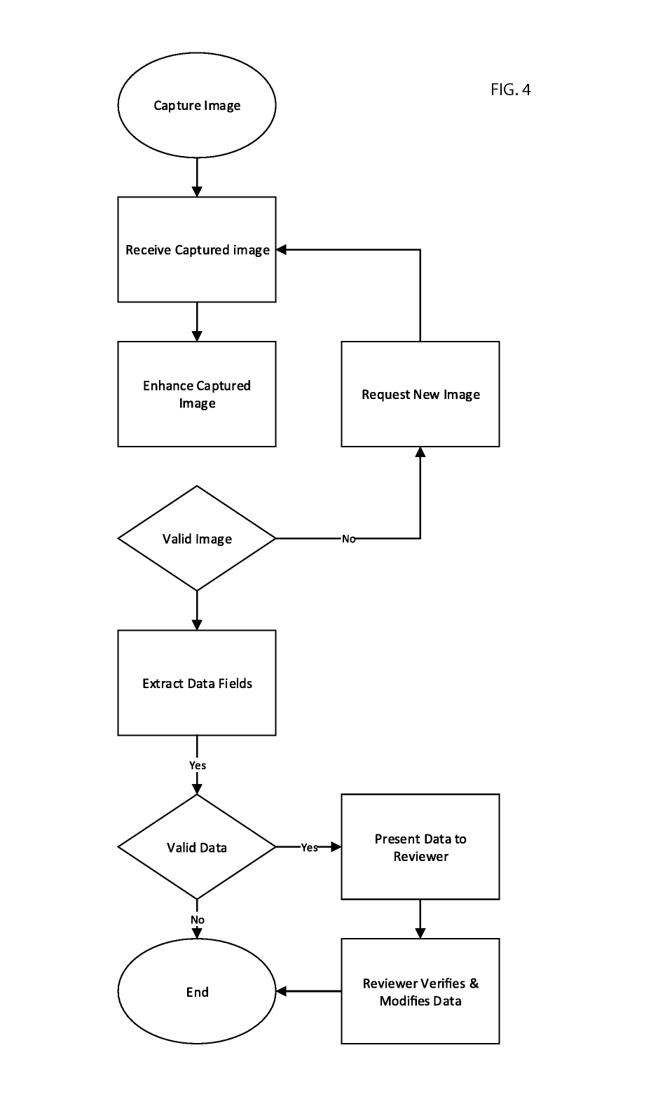

Referring next to FIG. 4, there is shown a block diagram of an exemplary image acquisition processing method 4000 for use with embodiments of the present invention. As shown in FIG. 4, image acquisition method generally comprises the steps of receiving a captured image; enhancing the captured image; extracting data field from the enhanced image; validating the data against a data base of known information; and presenting the validated data to a reviewer.

In greater detail the process of FIG. 4, begins with a person taking a picture of a transaction document with a smart phone. The transaction document may be an invoice, a check, or any other document with payment sending or receipt instructions. Next, the image is received by the system, usually by uploading the image into the system.

The uploaded image is then enhanced to be in a form from which software may extract any desired data such as account numbers, names, dates, addresses, etc. This extracted data is then compared to (validated against) known information in a database that may include prior transaction information from a particular user of the system and/or a database of information from all users (payers and payees) within the system. In the event that the image cannot be enhanced sufficiently to be validated in this manner, the system requests a new image from the user.

After the data is validated, it is presented to a reviewer who makes any necessary update or edits to the data fields in advance of further processing or the instructed financial transaction.

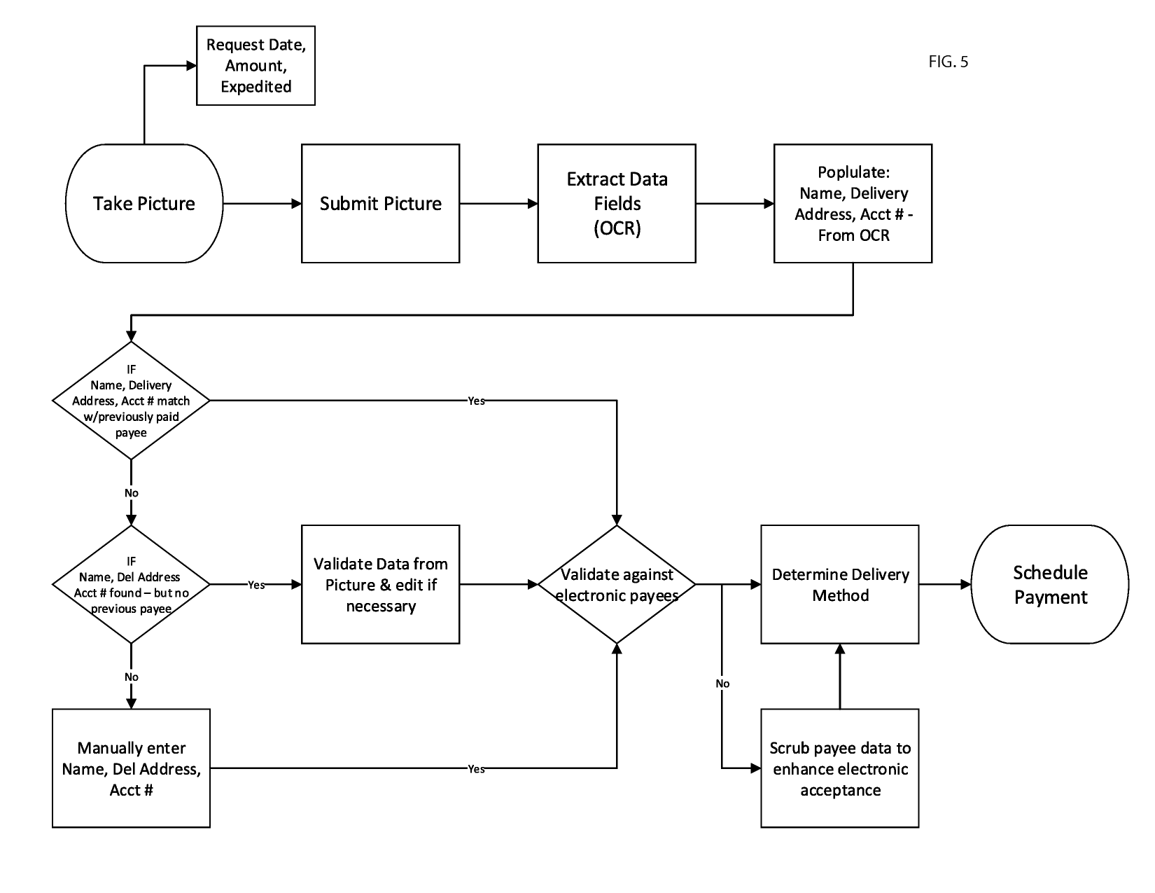

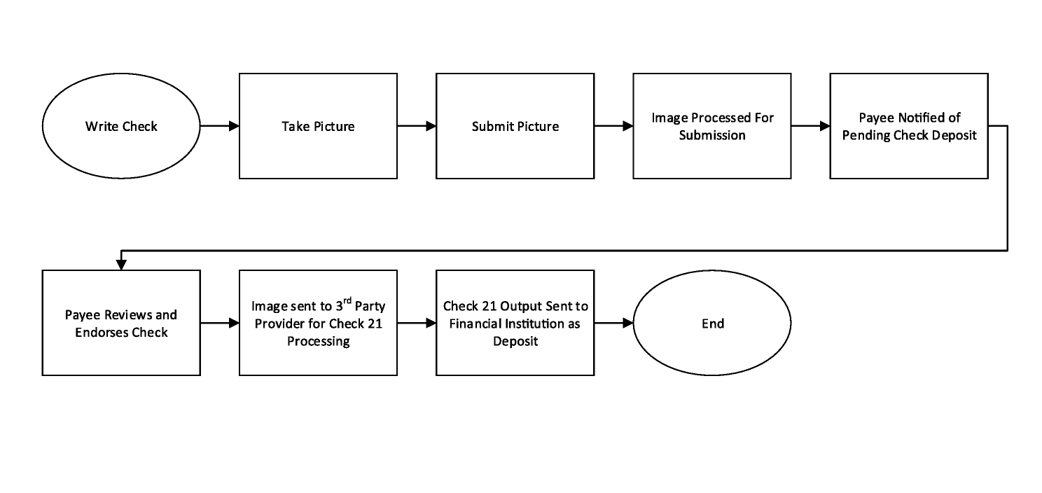

Turning now to FIG. 5, there is shown a flow diagram of a first exemplary embodiment of a transaction document processing method 5000 according to the present invention.

Turning generally to FIGS. 1-5 and especially FIG. 5, the method of the present invention is described as follows: a user captures the image of a transaction document using mobile device 110. The captured image is enhanced locally by mobile device 110 or is received and enhanced remotely by transaction server 140. For paying bills, a user captures the image of a bill or a remittance coupon using mobile device 110. The user can input various options for processing from mobile device 110, such as delivery method, delivery date and amount.

The captured image of the coupon is sent to transaction server 140. After receiving the captured image, the image of the coupon is enhanced in processor 120.

The enhanced image of the coupon is next tested running one or more quality assurance tests within processor 120. If the enhanced image of the coupon fails the quality assurance test, the enhanced image is tested for finding any useable text within the enhanced image. This test can occur within processor 120 or in a different processor or server. If no useable text is found, the enhanced image is rejected and the user is instructed to capture another image. If useable text is found, data from the enhanced image is extracted in the transaction processor 16 or manually inputted.

If the enhanced image passes the quality assurance testing, the enhanced image can be further processed within the same processor 120 or sent to a different processor either within the same transaction server 140 or a second transaction server, such as remote server 130. Text is extracted from the processed image of the coupon and identified. The data fields are located within the processed image of the coupon and can include machine readable data.

A payment record is populated from the located data fields. Payment data fields in the payment record can include a payee name, a payee's account number for the payer and the payee's address.

The payment data fields in the payment record are compared with the like payment data fields in the payer's stored record. If all the payment data fields match, the payment record is a complete payment record and is ready for validation.

If all the payment data fields are present but not all of the payment data fields match a payer's stored records, the payment record is incomplete. The data from the payment data fields is validated. Invalid data, such as data misread from the OCR, can be corrected. The payment can be further processed from the payee's account number for the payer using data from a previous payment record to replace the invalid data in the payment data field of the new payment record. The data can also be retrieved manually from the enhanced image and edited. If the data is valid but not in the payer's stored record, any new data can be added to the transaction server 140 or remote server 130.

If any payment data fields are empty or missing from the incomplete record, the payment field is filled by inputting data. If an account number is found but no address, for example, the payment can be further processed from the account number using data from a previous payment record to input the missing address data. The data can also be retrieved manually from the enhanced image. If the missing data cannot be retrieved, the image is rejected and a message is sent back to the user to recapture the image.

When all the payment data fields are present and valid, the payment data fields of the complete payment record are validated against the payee information stored within the transaction server. If the payment data fields are not validated, then the payee data in the payment record is processed to enhance the acceptance for an electronic delivery from data stored within the transaction server. A delivery method is determined after validation against the payee and the payment is scheduled and made.

Referring now to FIG. 6, there is shown an embodiment of the present invention wherein a check can be deposited into a payee's account from a picture of the check without sending or giving the check to the payee or using a deposit slip. As illustrated in FIG. 6, this embodiment of the present invention generally comprises the steps of acquiring an electronic image of a transaction document; processing the image of the transaction document; notifying the payee of the pending deposit; payee electronically endorsing the check; and sending the image to a provider for “Check 21” processing.

After taking an image of a transaction document, the payer (or check writer) accesses the payee's account through a transaction server 140. The payer then uploads an image of the transaction document to transaction server 140 which makes a deposit into the Payees account from the image taken on the check writer's mobile device 110.

The check writer captures the image of a filled out check using the mobile device 110, which is then sent to transaction server 140. After receiving the captured check image, the check image is enhanced in the processor 120 of transaction server 140 or a remote server 130.

The enhanced check image is next tested running one or more quality assurance tests within processor 120. If the enhanced check image fails the quality assurance test, the enhanced image is tested for finding any useable text within the enhanced image. If no useable text is found, the enhanced check image is rejected and the user is instructed to capture another image.

If the enhanced check image passes the quality assurance testing, the enhanced check image can be further processed. A check record is create and populated from the located check data fields. Check data fields in the check record can include: check writer's name, address, account number, bank account and bank routing information; amount of the check; date; payee's name and account information. If all of the check data fields are present, the check record is incomplete. Missing check data fields from the check record are filled in by inputting data. The data can be retrieved manually from the enhanced image. If the missing data cannot be retrieved, the image is rejected and a message is sent back to the user to recapture the image.

When all the check data fields are present and the check record is complete, the check is then credited to the payee's account in transaction server 140.

The above-described embodiments are merely exemplary illustrations set forth for a clear understanding of the principles of the invention. Many variations, combinations, modifications, or equivalents may be substituted for elements thereof without departing from the scope of the invention. It should be understood, therefore, that the above description is of an exemplary embodiment of the invention and included for illustrative purposes only. The description of the exemplary embodiment is not meant to be limiting of the invention. A person of ordinary skill in the field of the invention or the relevant technical art will understand that variations of the invention are included within the scope of the claims.

1. A computer implemented method for financial transaction processing, the method comprising the steps of: receiving a captured image of a transaction document; identifying text and any machine readable data on the image; extracting data fields from the image; populating a transaction record with transaction data fields from the extracted data fields; comparing and matching the transaction data fields of the transaction record with like data fields of a stored transaction record to determine if the transaction record is a complete transaction record or an incomplete transaction record, wherein the complete transaction record has all of the transaction data fields of the transaction record match all of the like data fields of the stored transaction record and wherein the incomplete transaction record has at least one unmatched transaction data field of the transaction record fail to match one of the like data fields of the stored transaction record; determining if the unmatched transaction data field from the incomplete transaction record contains invalid data, and editing the invalid data of the unmatched data field to match the like data field of the stored transaction record; determining if the unmatched transaction data field from the incomplete transaction record contains new valid data, and inputting the new valid data into a like data field of a new stored record; determining if the unmatched transaction data field from the incomplete transaction record is empty, and inputting data into the empty data field to match the like data field of the stored transaction record; validating the transaction data fields of the complete transaction record; and scheduling an outcome of the financial transaction.

2. The method of claim 1, further comprising the step of electronically enhancing the captured image.

3. The method of claim 1, further comprising the step of storing new validated data for future reference.

4. The method of claim 1, further comprising the step of maintaining a user specific data base of transactional data.

5. The method of claim 1, further comprising the step of depositing a payment in a specific financial account.

6. The method of claim 1, further comprising the step of withdrawing a payment from a specific financial account.

7. The method of claim 1, further comprising the step of adding payee information to the global payee database.

8. The method of claim 1, further comprising the step of selecting a payment delivery method from the group consisting of electronic check, direct deposit, a paper check, and Internet electronic currency transaction.

9. A computer implemented method of performing a financial transaction, the method comprising the steps of: acquiring an electronic image of a transaction document; extracting data from said transaction document; inputting user specific data; populating predetermined data fields from said transaction document data and said user specific data; maintaining a first database of user specific payee information; maintaining a second data base of all payees; comparing said populated data fields to said user specific payee information; if said transaction and user inputted data match the data fields of said first database, validate said data against said second database, then execute the financial transaction; if said transaction and user inputted data does not match the data fields of said first database, manually enter unmatched information and validate said data against said second database, then execute the transaction.

10. The method of claim 9, further comprising the step of selecting a method of executing the financial transaction, where said method of executing is selected from the group consisting of an electronic check, direct deposit, a paper check, and Internet electronic currency transaction.

11. The method of claim 9, further comprising the step of storing a list of available payment methods for each payee.

12. The method of claim 9, further comprising the step of electronically enhancing the captured image.

13. The method of claim 9, further comprising the step of storing new validated data for future reference.

14. The method of claim 9, further comprising the step of maintaining a user specific data base of transactional data.

15. The method of claim 9, further comprising the step of depositing a payment in a specific financial account.

16. The method of claim 9, further comprising the step of withdrawing a payment from a specific financial account.

17. The method of claim 9, further comprising the step of adding payee information to the global payee database.

18. The method of claim 9, further comprising the step of selecting a payment delivery method from the group consisting of check, automatic bank transfer, money order, and electronic peer to peer payment.

19. A system for performing financial transactions based on images of transaction documents, the system comprising: a means for acquiring an electronic image; a means for extracting data from said image; means for populating predetermined data fields with said extracted data; a first database of user specific prior payee information; means for comparing populated data fields to said user specific prior payee information; means for determining a result of said comparison, where said result is selected from the group consisting of a complete match of said data fields to a prior payee, a partial match of said data fields to a prior payee, and no match of said data fields to a prior payee; means for selectively electronically and manually completing incomplete data fields with payee information; means for comparing said completed data fields with as database of all payees; means for updating said databases with new data; means for identifying acceptable payment methods for each payee; means for selecting a payment method among said acceptable payment methods; and means for executing said payment.
